(19) United States
(12) Patent Application Publication
(10) Pub. No.: US 2026/0187960 A1
(43) Pub. Date: Jul. 2, 2026

(54) INFORMATION PROCESSING SYSTEM, CONTROL SYSTEM, AND CONTROLLABLE IMAGE SENSOR

(71) Applicant: Sony Semiconductor Solutions Corporation, Kanagawa (JP)

(72) Inventors: Junya KAMEYAMA, Kanagawa (JP); Satoshi MIURA, Kanagawa (JP); Masami GOSEKI, Kanagawa (JP); Shoichi GOTO, Kanagawa (JP)

(73) Assignee: Sony Semiconductor Solutions Corporation, Kanagawa (JP)

(21) Appl. No.: 19/131,540

(22) PCT Filed: Nov. 28, 2023
(86) PCT No.: PCT/JP2023/042625

§ 371 Date: May 21, 2025

(30) Foreign Application Priority Data
Nov. 29, 2022 (JP) 2022-189910

(51) Int. Cl. G06V 10/25; G06T 7/80; G06V 10/82; G06V 10/98

(52) U.S. Cl. CPC G06V 10/25; G06T 7/80; G06V 10/82; G06V 10/993; G06T 2207/10016; G06T 2207/20081; G06T 2207/20084

(57) ABSTRACT

An information processing system includes circuitry configured to set a region of interest (ROI) as a subportion of an image, the image comprising image data, flatten image data corresponding to the ROI to create flattened ROI image data, and apply the flattened ROI image data to a trained AI engine to detect a presence or absence of a feature in the subportion of the image.

### TECHNICAL FIELD

The present disclosure relates to an information processing system, a control system, and a controllable image sensor.

### BACKGROUND ART

A technique for performing recognition processing on a captured image captured by a camera using artificial intelligence (AI) is known.

### CITATION LIST

### Patent Literature

PTL 1: JP 2020-068522 A.

### SUMMARY

### Technical Problems

Improvement of recognition accuracy in the recognition processing using AI for a captured image is required.

An aspect of the present disclosure is to provide an information processing system, a control system, and a controllable image sensor capable of improving accuracy by recognition processing using AI for a captured image.

### Solutions to Problems

Among other things, an information processing system is disclosed that includes circuitry configured to set a region of interest (ROI) as a subportion of an image, the image comprising image data, flatten image data corresponding to the ROI to create flattened ROI image data, and apply the flattened ROI image data to a trained AI engine to detect a presence or absence of a feature in the subportion of the image.

### BRIEF DESCRIPTION OF DRAWINGS

FIG. 1A is a block diagram illustrating a configuration example of an information processing system according to each embodiment.

FIG. 1B is a block diagram illustrating a configuration example of an information processing system according to each embodiment.

FIG. 2 is a block diagram illustrating a hardware configuration of an example of a signal processing device applicable to each embodiment.

FIG. 3 is a block diagram illustrating a hardware configuration of an example of a camera applicable to each embodiment.

FIG. 4 is a functional block diagram of an example for explaining functions of the signal processing device according to a first embodiment.

FIG. 5(a), FIG. 5(b), FIG. 5(c), and FIG. 5(d) are schematic diagrams for explaining a process according to a first example of the first embodiment.

FIG. 6 is a flowchart of an example illustrating the first process according to the first example of the first embodiment.

FIG. 7 is a schematic diagram illustrating an example in which captured image data is divided into N small regions.

FIG. 8 is a flowchart of an example illustrating a second process according to the first example of the first embodiment.

FIG. 9(a), FIG. 9(b), and FIG. 9(c) are schematic diagrams for explaining a process according to a second example of the first embodiment.

FIG. 10 is a flowchart of an example illustrating the process according to the second example of the first embodiment.

FIG. 11(a), FIG. 11(b), and FIG. 11(c) are schematic diagrams for explaining reduction processing of a search region according to the second example of the first embodiment.

FIG. 12 is a functional block diagram of an example for explaining functions of a signal processing device according to a second embodiment.

FIG. 13 is a flowchart of an example illustrating a process according to the second embodiment.

FIG. 14 is a block diagram illustrating a configuration of an example of an information processing system according to a third embodiment.

FIG. 15 is a block diagram illustrating a configuration of an example of an information processing system according to a first example of the third embodiment.

FIG. 16 is a block diagram illustrating a configuration of an example of an information processing system according to a second example of the third embodiment.

FIG. 17 is a diagram illustrating an example of training and using a machine learning model in connection with the AI engines discussed herein.

### DESCRIPTION OF EMBODIMENTS

Hereinafter, embodiments of the present disclosure will be described in detail with reference to the drawings. Note that, in the following embodiments, the same parts are denoted by the same reference signs, and redundant description will be omitted.

Hereinafter, the embodiments of the present disclosure will be described in the following order.
1. Overview of Technology of Present Disclosure
2. Configuration Applicable to Each Embodiment
   2-1. System Configuration Example
   2-2. Hardware Configuration Example
3. First Embodiment
   3-1. First Example
   3-2. Second Example
4. Second Embodiment
5. Third Embodiment
   5-1. First Example
   5-2. Second Example

### 1. Overview of Technology of Present Disclosure

First, the technology of the present disclosure will be schematically described. In the present disclosure, for example, signal processing is executed on a part or the whole of a captured image captured by a camera to maximize an image feature amount in a target region. Artificial intelligence (AI) processing using AI, for example, recognition processing is executed on the image in which the image feature amount is maximized. By executing the recognition processing by AI on the image in which the image feature amount is maximized, it is possible to acquire a recognition result with higher accuracy. Furthermore, the present disclosure also proposes a calibration method for a camera and signal processing based on an image feature amount suitable for an AI task.

### 2. Configuration Applicable to Each Embodiment

Next, a configuration applicable to each embodiment will be described.

### (2-1. System Configuration Example)

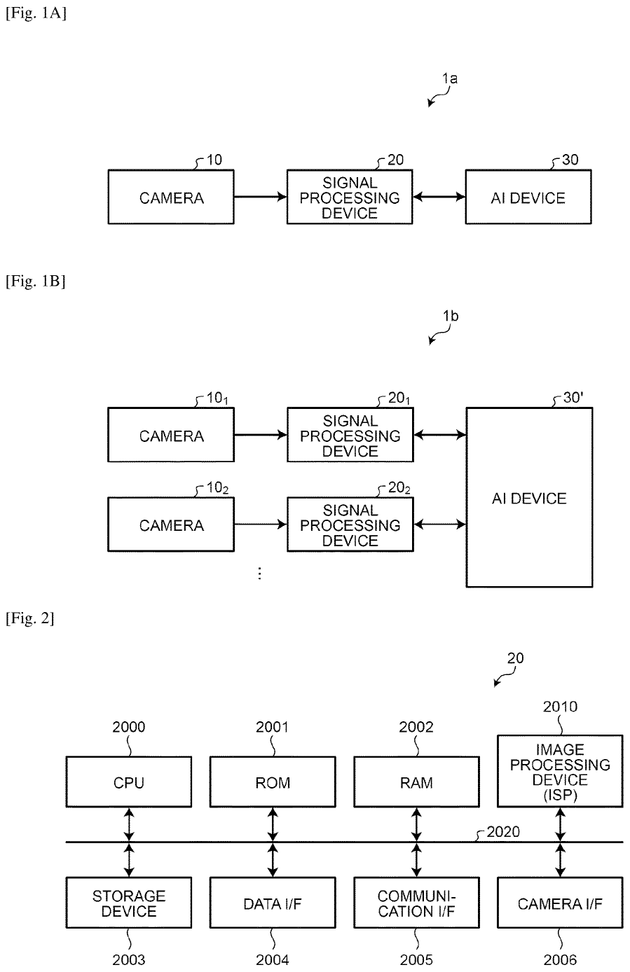

FIGS. 1A and 1B are block diagrams illustrating a configuration example of an information processing system according to each embodiment.

In FIG. 1A, an information processing system la includes a camera 10, a signal processing device 20, and an AI device 30, which are connected in a wired or wireless manner. The camera 10 images a subject and outputs a captured image obtained by imaging. More specifically, the camera 10 captures a moving image at a predetermined frame rate, and outputs a captured image for each frame.

The signal processing device 20 acquires the captured image output from the camera 10 and performs predetermined signal processing on the acquired captured image. For example, the signal processing device 20 may set a search region that is a candidate for a region of interest where the AI device 30 performs AI processing on the acquired captured image. The search region may be a small region of a part of the captured image, or may be a large region including the entire captured image.

Furthermore, the signal processing device 20 may perform signal processing for maximizing the image feature amount of the set search region. The signal processing device 20 may perform conversion processing on the luminance information as signal processing for maximizing the image feature amount. More specifically, the signal processing device 20 may apply histogram flattening as the signal processing.

The histogram flattening is processing of performing density conversion so that a histogram of pixel values becomes flat as a whole. In an image with low contrast, a frequency of pixel values is concentrated in a certain luminance band. Therefore, it is possible to obtain an image with high contrast by flattening the histogram. By increasing the contrast of the image by histogram flattening, the image feature amount (sometimes referred to as an image feature weight) by the image can be maximized.

The signal processing device 20 passes the image obtained by performing the above-described signal processing on the captured image to the AI device 30.

The signal processing device 20 may further receive a processing result obtained by performing the AI processing on the image of the search region from the AI device 30. The signal processing device 20 may determine a region of interest to be continuously processed from the search region on the basis of the processing result received from the AI device 30.

The AI device 30 has, for example, a model learned in advance, and use the model to execute processing by AI on the image passed from the signal processing device 20. More specifically, the AI device 30 extracts an image feature amount indicating a feature of an image from the image passed from the signal processing device 20, and executes processing by AI on the basis of the extracted image feature amount. The processing (Hereinafter, the processing is appropriately referred to as AI processing) by AI executed by the AI device 30 is not particularly limited, but may be, for example, recognition processing based on an image feature amount using a convolutional neural network (CNN). The AI device 30 may pass a processing result by the AI processing to the signal processing device 20. Furthermore, the AI device 30 may output the processing result by the AI processing to the outside. Moreover, the AI device 30 may output the extracted image feature amount to the outside.

Note that, in FIG. 1A, the camera 10, the signal processing device 20, and the AI device 30 are illustrated as independent devices, but this is not limited to this example. For example, the camera 10 and the signal processing device 20 may be integrally configured. Similarly, the signal processing device 20 and the AI device 30 may be integrally configured, or the camera 10, the signal processing device 20, and the AI device 30 may be integrally configured. Moreover, the AI device 30 is not limited to a single device, and may be, for example, a system configured on a cloud network.

FIG. 1B is a block diagram illustrating another configuration example of the information processing system applicable to each embodiment. In FIG. 1B, an information processing system 1b includes a plurality of cameras 10₁, 10₂, . . . , and a plurality of signal processing devices 20₁, 20₂, . . . connected to the cameras 10₁, 10₂, . . . , respectively. Each of the signal processing devices 20₁, 20₂, . . . is connected to an AI device 30′.

The AI device 30′ extracts an image feature amount from the image passed from each of the signal processing devices 20₁, 20₂, . . . , executes AI processing such as recognition processing on the basis of the extracted image feature amount, returns a processing result by the AI processing to each of the signal processing devices 20₁, 20₂, . . . , and outputs the processing result to the outside.

The information processing system 1b illustrated in FIG. 1B performs conversion processing of luminance information such as histogram flattening on each captured image by each of the cameras 10₁, 10₂, . . . in order to maximize the image feature amount by each of the signal processing devices 20₁, 20₂, . . . With this processing, in the extraction of the image feature amount based on the captured image, for example, a difference in imaging conditions (such as different illumination conditions) of the cameras 10₁, 10₂, . . . can be absorbed.

The information processing systems 1a and 1b illustrated in FIGS. 1A and 1B, respectively, can be applied to, for example, a monitoring system that performs monitoring based on a captured image. For example, in the information processing system 1b illustrated in FIG. 1B, an object (for example, a person) common in the captured images may be specified on the basis of the captured images by the cameras 10₁, 10₂, . . . Furthermore, also in the information processing system la illustrated in FIG. 1A, an object (for example, a person) common in each captured image may be specified on the basis of each captured image in a time-series column direction captured by the camera 10. The monitoring system to which the information processing system 1a or 1b is applied can track the object (person) specified in this way.

### (2-2. Hardware Configuration Example)

Next, a hardware configuration example applicable to each embodiment will be described.

FIG. 2 is a block diagram illustrating a hardware configuration of an example of the signal processing device 20 applicable to each embodiment.

In FIG. 2, the signal processing device 20 includes a central processing unit (CPU) 2000, a read only memory (ROM) 2001, a random access memory (RAM) 2002, a storage device 2003, a data interface (I/F) 2004, a communication I/F 2005, and a camera I/F 2006, and these units are communicably connected to each other via a bus 2020. Furthermore, the signal processing device 20 may further include an image processing device 2010. The image processing device 2010 is connected to the bus 2020 and is communicably connected to each unit of the signal processing device 20.

The storage device 2003 is a nonvolatile storage medium such as a flash memory or a hard disk drive. The CPU 2000 controls the entire operation of the signal processing device 20 by using the RAM 2002 as a work memory according to a program stored in the ROM 2001 and the storage device 2003.

The data I/F 2004 controls input/output of data to/from an external device. For example, the data I/F 2004 may control input/output of data to/from the camera 10 and input/output of data to/from the AI device 30. The data I/F 2004 may be an interface of a system unique to a device (the camera 10, the AI device 30) to be connected, and the data I/F 2004 may be a general-purpose interface such as a universal serial bus (USB) or Bluetooth (registered trademark), for example.

The communication I/F 2005 controls communication via a communication network such as a local area network (LAN) or the Internet.

The camera I/F 2006 is an interface for communicating with the camera 10. The signal processing device 20 receives image data output from the camera 10 by the camera I/F 2006 and passes the image data to, for example, the CPU 2000. In the example of FIG. 2, the camera I/F 2006 is illustrated as an independent block, but this is not limited to this example, and for example, the data I/F 2004 can be used as the camera I/F 2006.

The image processing device 2010 may be, for example, an image signal processor (ISP), and performs image processing on image data supplied via the bus 2020 in accordance with an instruction from the CPU 2000. A result of the image processing by the image processing device 2010 is passed to, for example, the CPU 2000.

Note that, in a case where the image processing executed by the image processing device 2010 can be executed by the CPU 2000, the image processing device 2010 can be omitted.

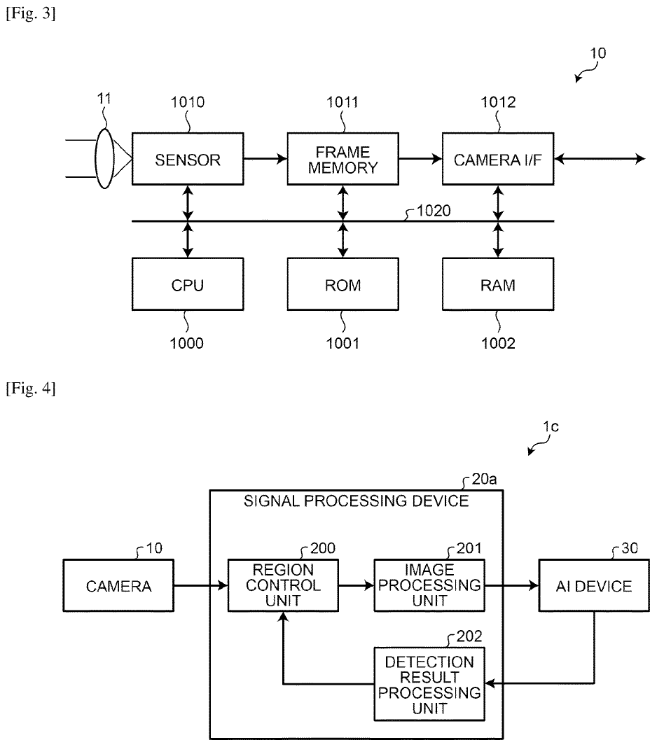

FIG. 3 is a block diagram illustrating a hardware configuration of an example of the camera 10 applicable to each embodiment. In FIG. 3, the camera 10 includes a CPU 1000, a ROM 1001, a RAM 1002, a sensor 1010, a frame memory 1011, and a camera I/F 1012, and these units are communicably connected to each other via a bus 1020.

The CPU 1000 controls the entire operation of the camera 10 by using the RAM 1002 as a as a local memory” accessible during execution of programs stored on the ROM 1001 according to a program stored in the ROM 1001.

The sensor 1010 includes a pixel array in which pixels that convert received light into electrical signals are arranged in a matrix array, a drive circuit that drives each pixel included in the pixel array, and a signal processing circuit that performs predetermined signal processing such as noise removal and gain adjustment on an electrical signal (pixel signal) read from each pixel. Furthermore, the signal processing circuit further includes an analog to digital (AD) conversion circuit that converts the pixel signal read as an analog signal from each pixel into a digital signal (pixel data).

In the sensor 1010, light incident through an optical unit 11 including a lens, a diaphragm mechanism, an autofocus mechanism, and the like irradiates an irradiation surface of the pixel array. The sensor 1010 performs exposure in each pixel, converts an analog pixel signal read from each pixel by the exposure into digital pixel data, and outputs the digital pixel data. The pixel data output from the sensor 1010 is stored in the frame memory 1011. When pixel data for one frame is stored in the frame memory 1011, the pixel data is read from the frame memory 1011 as image data of a frame image.

Note that the image data of one frame is data based on the pixel signal read from an effective pixel region in the pixel array in one frame period.

The camera I/F 1012 is an interface for communicating with an external device (for example, the signal processing device 20). The camera 10 outputs captured image data from the camera I/F 1012 to the outside. More specifically, the camera 10 outputs the image data for one frame read from the frame memory 1011 from the camera I/F 1012 as captured image data. Note that the captured image data may be appropriately referred to as captured image. Furthermore, the camera I/F 1012 may input and output various data including a command to and from an external device.

Note that the AI device 30 (sometimes referred to as an AI engine)includes a CPU, a ROM, a RAM, a storage device, a communication I/F, and the like, where the CPU is circuitry that is configured by its execution of computer readable instructions that are stored in memory. A model for the AI processing executed by the AI device 30 is stored in, for example, the storage device.

### 3. First Embodiment

Next, a first embodiment of the present disclosure will be described. In the first embodiment of the present disclosure, a system for automatically searching for a region of interest for the AI device 30 to continuously perform AI processing is proposed. More specifically, in the first embodiment, image processing for maximizing an image feature amount is performed on a search region by an entire captured image or a small region, AI processing is executed by the AI device 30, and on the basis of a result of the processing, a region of interest for the AI device 30 to continuously perform the AI processing is determined.

Note that, in the following description, unless otherwise specified, the AI device 30 executes recognition processing for performing object detection as AI processing.

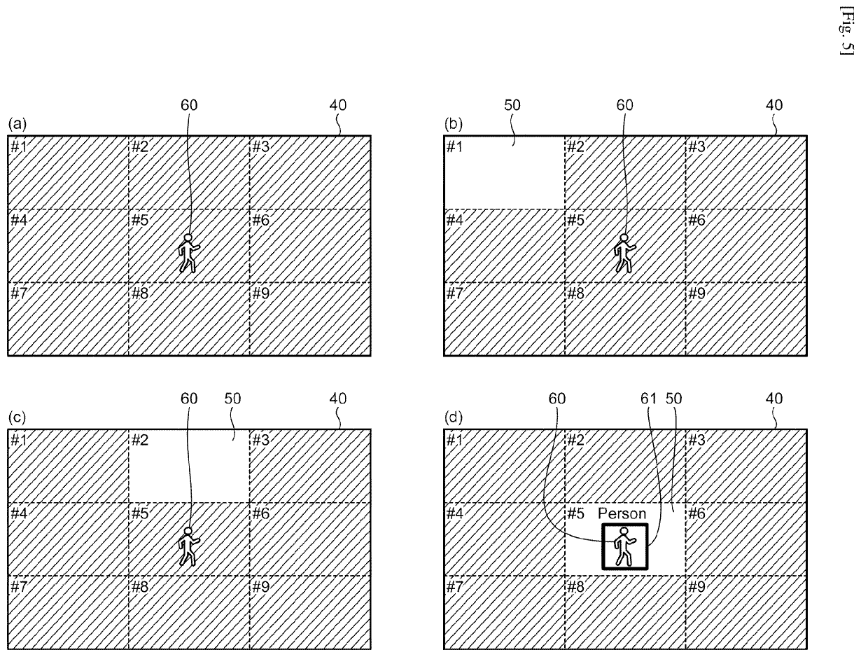

FIG. 4 is a functional block diagram of an example for explaining functions of a signal processing device 20 according to the first embodiment. While the camera 10, signal processing device 20a, and AI device 30 are shown as separate devices, it should be understood that these components, in this embodiment and alternative embodiments, may also be part of common circuitry. One example of such circuitry is a stacked sensor, which includes an image sensor, along with a programmable processor in a single circuit structure (e.g., interconnected semiconductors, such as a stacked image sensor).

In FIG. 4, a signal processing device 20a included in an information processing system 1c according to the first embodiment includes a region control unit 200, an image processing unit 201, and a detection result processing unit 202. While the term ‘unit’ is used herein, it should be understood that “units” of the signal processing device 20a may be implemented as software, which when executed on processing circuitry, configures the processing circuitry to implement the function performed by the unit. For example, the signal processing device 20 is implemented in circuitry that is configured (by software) to control a region of an image that is subsequently evaluated in image processing unit 201, and AI device 30 (which itself is implemented in programmable circuitry).

The region control unit 200, the image processing unit 201, and the detection result processing unit 202 may be configured by a signal processing program according to the first embodiment operating on the CPU 2000. The present disclosure is not limited thereto, and a part or all of the region control unit 200, the image processing unit 201, and the detection result processing unit 202 may be configured by a hardware circuit (ISP or the like) that operates in cooperation with each other.

The region control unit 200 sets a search region or a region of interest in a captured image output from the camera 10.

The image processing unit 201 performs image processing for maximizing an image feature amount on image data of the search region or the region of interest set by the region control unit 200. The image processing unit 201 passes the image data subjected to image processing to the AI device 30.

In the present disclosure, histogram flattening is performed as the image processing by the image processing unit 201 for maximizing feature prominence of a feature present in the image data. The histogram flattening is density conversion processing that flattens pixel values distributed in a histogram of pixel values. In other words, the histogram flattening processing can be referred to as conversion processing for luminance information of the image data. In an image with low contrast, a frequency of pixel values is concentrated in a certain luminance band. Therefore, it is possible to obtain an image with high contrast by flattening the histogram. By increasing the contrast of the image by histogram flattening, the image feature amount by the image can be maximized.

The detection result processing unit 202 acquires a detection result of the object by the recognition processing by the AI device 30. For example, the AI device 30 may generate a bounding box including the object on the basis of the object detected by the recognition processing, and output information indicating the generated bounding box as a detection result of the object. The information indicating the bounding box includes, for example, information indicating coordinates of the bounding box in the image. The coordinates of the bounding box may be represented by, for example, a maximum value and a minimum value in an X-axis direction, and a maximum value and a minimum value in a Y-axis direction. The detection result processing unit 202 executes processing of processing on the detection result acquired from the AI device 30.

Hereinafter, the “information indicating the bounding box” may be simply described as “bounding box”.

The region control unit 200 performs processing such as narrowing down of a search region and determination of a region of interest continuously recognized by the AI device 30 on the basis of information obtained by performing predetermined processing on the detection result of the AI device 30 by the detection result processing unit 202.

In the signal processing device 20, the CPU 2000 configures the region control unit 200, the image processing unit 201, and the detection result processing unit 202 described above in a main storage area of the RAM 2002, for example, as circuitry that is configured by its execution of program instructions so as to realize the functions according to the embodiment, as well as other embodiments disclosed herein.

The program can be acquired from the outside via a network (not illustrated) by communication via the communication I/F 2005, for example, and can be installed on the signal processing device 20. The present disclosure is not limited thereto, and the program may be provided by being stored in a detachable storage medium such as a compact disk (CD), a digital versatile disk (DVD), or a universal serial bus (USB) memory. The network may provide access to remote circuitry (e.g., cloud computer resources) that are configured to perform some or all of the processing functions described herein.

### (3-1. First Example)

A first example of the first embodiment will be described. The first example of the first embodiment is an example in which histogram flattening is performed on the captured image data for each predetermined small region, and an object is sequentially searched for.

FIG. 5(a), FIG. 5(b), FIG. 5(c), and FIG. 5(d) are schematic diagrams for explaining a process according to the first example of the first embodiment. In the signal processing device 20a, the region control unit 200 divides captured image data 40 into small regions. In the example of FIG. 5(a), the region control unit 200 divides the captured image data 40 into three in each of a height direction and a width direction, and into nine small regions #1 to #9. Here, it is assumed that an object 60 (in this case, a person) is included in the central small region #5.

In the signal processing device 20a, as illustrated in FIG. 5(b), the image processing unit 201 performs histogram flattening processing using, for example, the upper left small region #1 of the captured image data 40 as a search region 50 (the search region being a subportion of the captured image data 40), and passes the processed image data of the small region #1 to the AI device 30. The AI device 30 extracts an image feature amount from the image data of the small region #1 passed from the signal processing device 20a, and executes AI processing on the basis of the extracted image feature amount.

Similarly, as illustrated in FIG. 5(c), the image processing unit 201 then performs the histogram flattening processing with the small region #2 on the right of the small region #1 as the search region 50, and passes the processed image data of the small region #2 to the AI device 30. The AI device 30 extracts an image feature amount from the image data of the small region #2 passed from the signal processing device 20a, and executes the AI processing on the basis of the extracted image feature weight. Thereafter, the image processing unit 201 sequentially performs the histogram flattening processing with the image data of each of the small regions #3 to #9 as the search region 50 toward the lower right small region #9 of the captured image data 40 and passes the processed image data to the AI device 30. The AI device 30 sequentially executes the extraction processing of an image feature amount and the AI processing based on the extracted image feature amount for each image data of the small regions #3 to #9 passed from the signal processing device 20a.

Here, as illustrated in FIG. 5(d), it is assumed that the object 60 is detected in the small region #5 as the search region 50 in the AI device 30. The AI device 30 generates a bounding box 61 for the detected object 60 and passes information indicating the generated bounding box 61 to the signal processing device 20a.

In the signal processing device 20a, the detection result processing unit 202 counts the number of bounding boxes 61 set in the search region on the basis of the information indicating the bounding box 61 passed from the AI device 30. The detection result processing unit 202 passes the counted number of bounding boxes 61 to the region control unit 200.

The region control unit 200 compares the number of bounding boxes 61 in each of the small regions #1 to #9, and sets a small region having the largest number of bounding boxes 61 among the small regions #1 to #9 as a region of interest of the target on which the AI device 30 continuously performs the recognition processing.

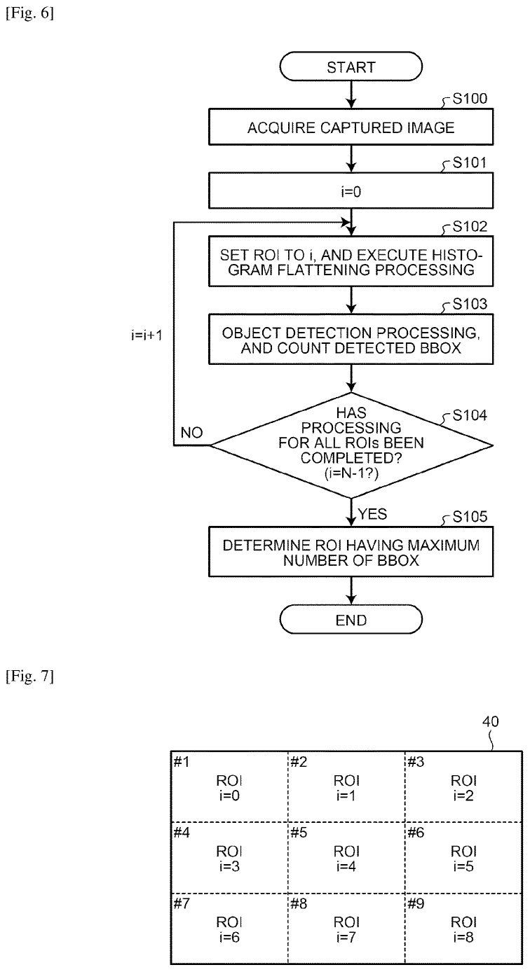

FIG. 6 is a flowchart of an example illustrating a first process according to the first example of the first embodiment. The first process illustrated in FIG. 6 is an example in a case where the signal processing device 20a includes an image storage memory capable of storing image data for at least one frame. The signal processing device 20a may apply a predetermined storage area of the RAM 2002 to the image storage memory. The present disclosure is not limited thereto, and the signal processing device 20a may separately provide a frame memory as an image storage memory.

Note that, here, it is assumed that the region control unit 200 divides the captured image data 40 into three subportions in each of the height direction and the width direction, and thus divides the captured image data into nine small regions. FIG. 7 is a schematic diagram illustrating an example in which the captured image data 40 is divided into N small regions. In the example of FIG. 7, N=9, and variables i=0 to i=8 in a case where the small region #1 at the upper left to the small region #9 at the lower right are set as search regions are allocated to the nine small regions #1 to #9 obtained by dividing the captured image data 40.

Note that, in FIGS. 6 and 7, the search region is illustrated as a region of interest (ROI) that is focused at that time.

In Step S100, the signal processing device 20a acquires the captured image data for one frame output from the camera 10, and stores the acquired captured image data in the image storage memory. In the next Step S101, the region control unit 200 in the signal processing device 20a sets the variable i to 0.

In the next Step S102, the region control unit 200 sets the search region (ROI) as a small region of the variable i with respect to the captured image data. The image processing unit 201 executes histogram flattening processing on the image data of the set search region. The image processing unit 201 passes the image data of the search region on which the histogram flattening processing has been executed to the AI device 30.

In the next Step S103, the AI device 30 extracts an image feature amount from the image data of the search region passed from the signal processing device 20a, and executes object detection processing of recognizing and detecting the object 60 on the basis of the extracted image feature amount. The AI device 30 passes the bounding box 61 including the object to the signal processing device 20a as a detection result of the object detection processing. The signal processing device 20a counts the number of bounding boxes 61 passed from the AI device 30 by the detection result processing unit 202.

In the next Step S104, the region control unit 200 determines whether or not the processing for all the search regions set in the captured image data has been completed. More specifically, the region control unit 200 determines whether or not the variable i =N−1 is satisfied. When determining that the processing for all the search regions has not been completed (Step S104, “No”), the region control unit 200 sets the variable i=i+1 and returns the process to Step S102.

On the other hand, in a case where the region control unit 200 determines that the processing for all the search regions has been completed (Step S104, “Yes”), the process proceeds to Step S105. In Step S105, the region control unit 200 sets the small region having the maximum number of bounding boxes 61 among the small regions of the variable i=0 to 8 as a region of interest of the target on which the AI device 30 continuously performs the recognition processing.

When the processing of Step S105 ends, a series of processing according to the flowchart of FIG. 6 ends.

Here, the signal processing device 20a periodically executes the processing according to the flowchart of FIG. 6 at predetermined time intervals, for example, once every several minutes, once every several 10 seconds, or the like. The time interval at which the processing is executed is not limited to this example, and is set according to the use case of the information processing system 1c. For example, in a case where the information processing system lc is applied to a monitoring system, the time interval may be set according to a timing at which the flow of people in the monitoring target greatly changes. For example, it is conceivable to set the time interval for each time zone of one day, for each predetermined day of the week, for each season, or the like.

The AI device 30 continuously executes the recognition processing for the region of interest determined in Step S105 of the flowchart of FIG. 6 until the process according to the flowchart is executed next and the region of interest is determined in Step S105.

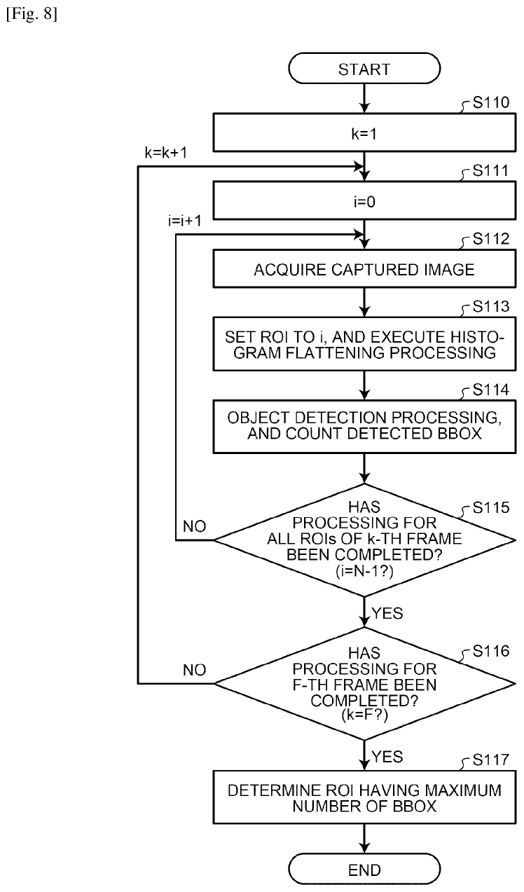

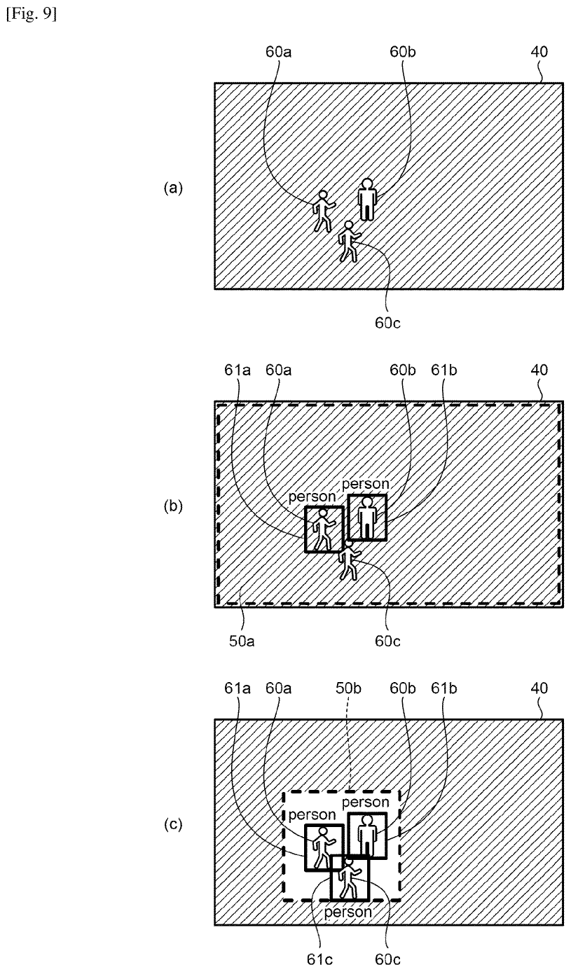

FIG. 8 is a flowchart of an example illustrating a second process according to the first example of the first embodiment. The second process illustrated in FIG. 8 is an example in a case where the signal processing device 20a does not include the image storage memory.

Note that, similarly to FIG. 7, it is assumed that the captured image data 40 for one frame is divided into nine (N=9) small regions #1 to #9 divided into three in each of the height direction and the width direction, and the captured image data 40 is obtained for an accumulated number of frames F (F is an integer; 1≤F). Furthermore, it is assumed that, in each captured image data 40 of the k-th (k is an integer; 1≤k≤F) frame in the accumulated number of frames F, the variable i (i=0, 1, . . . , 8) in a case where the small region #1 at the upper left to the small region #9 at the lower right are set as search regions is allocated.

In Step S110, the region control unit 200 in the signal processing device 20a sets the variable k=1. In the next Step S111, the region control unit 200 sets the variable i to 0.

In the next Step S112, the signal processing device 20a acquires the image data of the small region designated by the variable i of the k-th frame from the camera 10. For example, the signal processing device 20a selectively acquires image data included in the small region designated by the variable i from the captured image data 40 for one frame output from the camera 10 by the region control unit 200. Alternatively, the signal processing device 20a may selectively read the image data included in the small region designated by the variable i from the frame memory 1011 of the camera 10 by the region control unit 200.

In the next Step S113, the region control unit 200 sets a search region (ROI) to be a target of recognition processing of the AI device 30 as a small region of the variable i. The image processing unit 201 executes histogram flattening processing on the image data of the set search region acquired in Step S111. The image processing unit 201 passes the image data of the search region on which the histogram flattening processing has been executed to the AI device 30.

In the next Step S114, the AI device 30 extracts an image feature amount from the image data of the search region passed from the signal processing device 20a, and executes object detection processing of recognizing and detecting the object 60 on the basis of the extracted image feature amount. The AI device 30 passes the bounding box 61 including the object to the signal processing device 20a as a detection result of the object detection processing. The signal processing device 20a counts the number of bounding boxes 61 passed from the AI device 30 by the detection result processing unit 202.

In the next Step S115, the region control unit 200 determines whether or not the processing for all the search regions set in the captured image data of the k-th frame has been completed. More specifically, the region control unit 200 determines whether or not the variable i=N−1 is satisfied. When determining that the processing for all the search regions has not been completed for the k-th frame (Step S115, “No”), the region control unit 200 sets the variable i=i+1 and returns the process to Step S112.

On the other hand, when determining that the processing for all the search regions of the kth frame has been completed (Step S115, “Yes”), the region control unit 200 shifts the process to Step S116.

In Step S116, the region control unit 200 determines whether or not the processing on the captured image data of the F-th frame has been completed. More specifically, the region control unit 200 determines whether or not the variable k=F is satisfied. In a case where the region control unit 200 determines that the processing on the captured image data of the F-th frame has not been completed (Step S116, “No”), the region control unit sets the variable k=k+1 and returns the process to Step S111.

On the other hand, in a case where the region control unit 200 determines in Step S116 that the processing for the captured image data of the F-th frame has been completed (Step S116, “Yes”), the process proceeds to Step S117.

In Step S117, the region control unit 200 integrates the number of bounding boxes 61 of each of the small regions of the variable i =0 to 8 for the captured image data of each of the first to F-th frames. The region control unit 200 obtains the number of bounding boxes 61 in which F frames of each of the small regions of the variable i =0 to 8 are integrated, and sets the small region having the maximum obtained number as a region of interest of the target on which the AI device 30 continuously performs the recognition processing.

When the processing of Step S117 ends, a series of processing according to the flowchart of FIG. 8 ends.

The signal processing device 20a periodically executes the processing according to the flowchart of FIG. 8 at predetermined time intervals, for example, once every several minutes, once every several 10 seconds, or the like, similarly to the flowchart of FIG. 6 described above. The AI device 30 continuously executes the recognition processing for the region of interest determined in Step S117 of the flowchart of FIG. 8 until the processing according to the flowchart is executed next and the region of interest is determined in Step S117.

In the second method of the first example of the first embodiment, since the image data of each small region is acquired each time of processing, for example, there may be a case where the image data is acquired from different frames in time series in the small region #1 and the small region #9. Therefore, in the second method of the first example of the first embodiment, it is possible to suppress the time-series information blur of each small region by integrating the information of each small region over a plurality of frames.

As described above, in the first example of the first embodiment, the image feature amount is maximized for each small region obtained by dividing the captured image data, and the object detection is executed. Moreover, among the small regions, the small region in which the number of detected objects 60 (bounding boxes 61) is the maximum is determined as the region of interest in which the AI device 30 continuously executes the recognition processing. That is, in the first example of the first embodiment, the recognition processing by the AI device 30 can be executed for the small region narrowed down from the captured image data and having the maximum image feature amount, and the recognition accuracy in the recognition processing can be improved.

(3-2. Second Example) Next, a second example of the first embodiment will be described. A second example of the first embodiment is an example in which histogram flattening is performed on a large region of the captured image data, for example, a region including the entire captured image data to search for an object, the region is narrowed in a direction in which a large number of objects are detected, and the search region of the objects is narrowed.

FIG. 9(a), FIG. 9(b), and FIG. 9(c) are schematic diagrams for explaining a process according to the second example of the first embodiment. As illustrated in FIG. 9(a), it is assumed that captured image data 40 includes, for example, objects 60a, 60b, and 60c that are persons, respectively.

In the second example of the first embodiment, in the signal processing device 20a, as illustrated in FIG. 9(b), the region control unit 200 first sets a large region including the entire captured image data 40 as a search region 50a, and executes the recognition processing by the AI device 30 on the search region 50a. In the example of FIG. 9(b), among the objects 60a to 60c, the objects 60a and 60b are detected by the recognition processing, and bounding boxes 61a and 61b are generated, respectively.

The region control unit 200 narrows down the search region 50a based on the bounding boxes 61a and 61b of the detection result, and generates a new search region 50b as illustrated in FIG. 9(c). In this example, by executing the recognition processing by the AI device 30 on the search region 50b, the object 60c is detected in addition to the objects 60a and 60b, and a bounding box 61c for the object 60c is additionally generated.

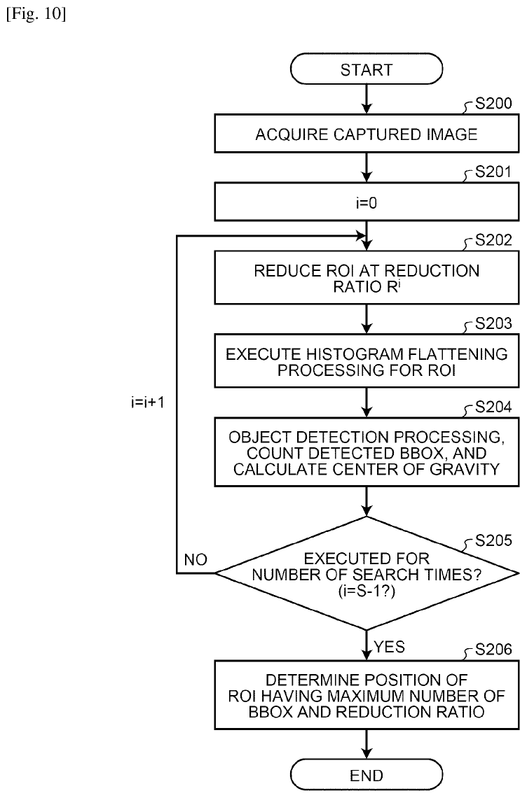

FIG. 10 is a flowchart of an example illustrating the process according to the second example of the first embodiment. Here, the description will be given assuming that the signal processing device 20a includes an image storage memory capable of storing image data for at least one frame.

In Step S200, the signal processing device 20a acquires the captured image data for one frame output from the camera 10, and stores the acquired captured image data in the image storage memory. In the next Step S201, the region control unit 200 in the signal processing device 20a sets the variable i=0. Note that, although not illustrated, in the signal processing device 20a, the region control unit 200 sets a large region including the entire captured image data of one frame as a search region in the steps up to Step S201.

In the next Step S202, in the signal processing device 20a, the region control unit 200 reduces the search region (ROI) at a reduction ratio Rⁱ. Note that the value R is a fixed value satisfying 0<R<1. When the variable i=0, the reduction ratio Rⁱ=1, and the search region is not reduced. When the value R is 0.5 and the variable i=1, the reduction ratio Rⁱ=0.5, and the search region is reduced such that a width W and a height H of the original search region are each 0.5 times, for example.

A method of reducing the search region is not limited to this example. For example, an area of the original search region may be reduced according to the reduction ratio.

Note that a center when the search region is reduced is a center position of a screen based on the captured image data in a case where the variable i=0, that is, in the initial value. In a case where the variable i≥1, a position of the center of gravity of a plurality of bounding boxes 61 to be described later becomes a center when the search region is reduced.

In the next Step S203, the image processing unit 201 executes histogram flattening processing on the image data of the search region subjected to the reduction processing in Step S202. The image processing unit 201 passes the image data of the search region on which the histogram flattening processing has been executed to the AI device 30.

In the next step S204, the AI device 30 extracts an image feature amount from the image data of the search region passed from the signal processing device 20a, and executes object detection processing of recognizing and detecting the object 60 on the basis of the extracted image feature amount. The AI device 30 passes the bounding box 61 including the object to the signal processing device 20a as a detection result of the object detection processing. The signal processing device 20a counts the number of bounding boxes 61 passed from the AI device 30 by the detection result processing unit 202.

Moreover, in a case where the plurality of bounding boxes 61 is passed from the AI device 30 in Step S204, the detection result processing unit 202 calculates coordinates of the centers of gravity of the plurality of bounding boxes 61.

In the next Step S205, the region control unit 200 determines whether or not the processing of steps S202 to S204 has been executed for a preset number of search times S. More specifically, the region control unit 200 determines whether or not the variable i=S−1. When determining that the number of executions of the processing in steps S202 to S204 has not reached the search number of times S (Step S205, “No”), the region control unit 200 sets the variable i=i+1 and returns the process to Step S202.

On the other hand, in a case where the region control unit 200 determines that the number of executions of the processing in steps S202 to S204 has reached the search number S), “Yes” in Step S205), the process proceeds to Step S206.

Note that, in a case where the plurality of bounding boxes 61 are present in the captured image data 40, the processing of steps S202 to S204 may be executed for each of the combinations of the plurality of bounding boxes 61. Furthermore, in a case where there is a plurality of clusters of the plurality of bounding boxes close to each other in the captured image data 40, the processing of steps S202 to S204 may be executed for each of the plurality of clusters.

In Step S206, the region control unit 200 sets the search region having the maximum number of bounding boxes 61 as a region of interest of the target on which the AI device 30 continuously performs the recognition processing.

When the processing of Step S206 ends, a series of processing according to the flowchart of FIG. 10 ends.

Here, the signal processing device 20a periodically executes the processing according to the flowchart of FIG. 10 at predetermined time intervals, for example, once every several minutes, once every several 10 seconds, or the like. The AI device 30 continuously executes the recognition processing for the region of interest determined in Step S206 of the flowchart of FIG. 10 until the processing according to the flowchart is executed next and the region of interest is determined in Step S206.

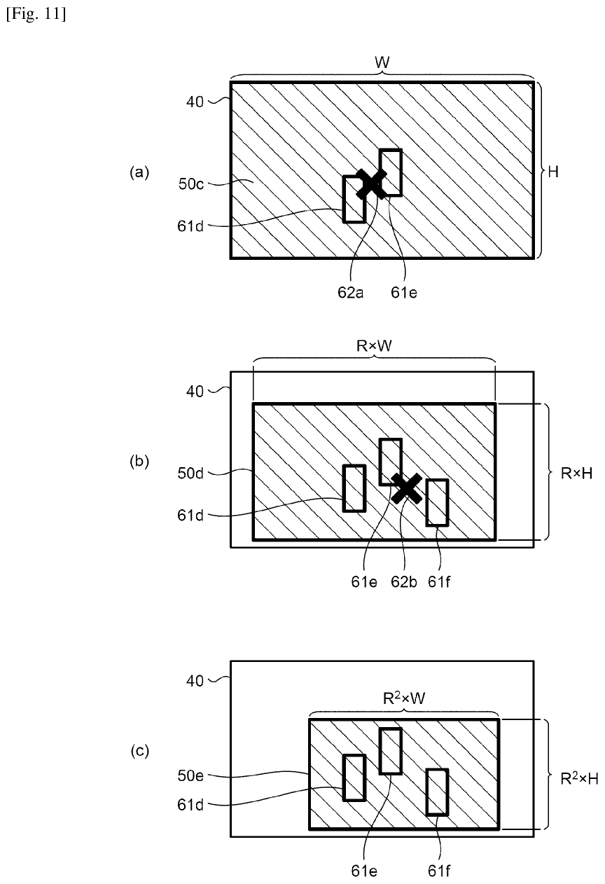

FIG. 11(a), FIG. 11(b), and FIG. 11(c) are schematic diagrams for explaining reduction processing of a search region according to the second example of the first embodiment. Here, it is assumed that a size of an image based on captured image data 40 is width W ×height H.

For example, at a stage of the variable i=0, as illustrated in FIG. 11(a), it is assumed that two objects are detected in a search region 50c including the entire captured image data 40, and bounding boxes 61d and 61e are generated. In this case, in Step S204 of the flowchart of FIG. 10, the detection result processing unit 202 calculates coordinates 62a of the center of gravity of the bounding box 61d and the bounding box 61e on the basis of the coordinate information of the bounding box 61d and the coordinate information of the bounding box 61e.

At a stage of the variable i=1, as illustrated in a section (b) of FIG. 11, the search region 50c is reduced at the reduction ratio Rⁱ=R¹=R around the coordinates 62a of the center of gravity, and a search region 50d having a width W×R and a height H×R is set. It is assumed that one object is newly detected by the recognition processing of the AI device 30 with respect to the search region 50d, and a bounding box 61f by the object is generated. In this case, in Step S204 of the flowchart of FIG. 10, the detection result processing unit 202 calculates coordinates 62b of the center of gravity of the bounding box 61d, the bounding box 61e, and the bounding box 61f on the basis of the coordinate information of the bounding box 61d, the coordinate information of the bounding box 61e, and the coordinate information of the bounding box 61f.

Similarly at a stage of the next variable i=2, the search region 50d is reduced at the reduction ratio Rⁱ=R² around the coordinates 62b of the center of gravity, and a search region 50e having a width W×R² and a height H×R² is set.

In the second example of the first embodiment, the reduction processing of the search region 50 by the reduction ratio based on the variable i and the value R, and the recognition processing by the AI device 30 on the reduced search region 50 are repeatedly executed by the number of search times S.

As described above, in the second example of the first embodiment, the recognition processing is executed by maximizing the image feature amount with respect to the search region set for the captured image data, and the recognition processing is further executed by reducing the search region in the direction in which a large number of objects are detected by the recognition processing. Therefore, also in the second example of the first embodiment, the recognition processing by the AI device 30 can be executed for the search region narrowed down from the captured image data and having the maximum image feature amount, and the recognition accuracy in the recognition processing can be improved.

### 4. Second Embodiment

Next, a second embodiment of the present disclosure will be described.

An information processing system according to the second embodiment of the present disclosure performs predetermined signal processing on a search region or a region of interest set in a captured image in order to perform AI processing, and searches for an image feature amount with high similarity from a plurality of the image feature amounts.

More specifically, the information processing system according to the second embodiment performs conversion processing of luminance information with respect to the search region or the region of interest set for the captured image, and maximizes the image feature amount in the search region or the region of interest. As the conversion processing of the luminance information, for example, histogram flattening processing may be applied.

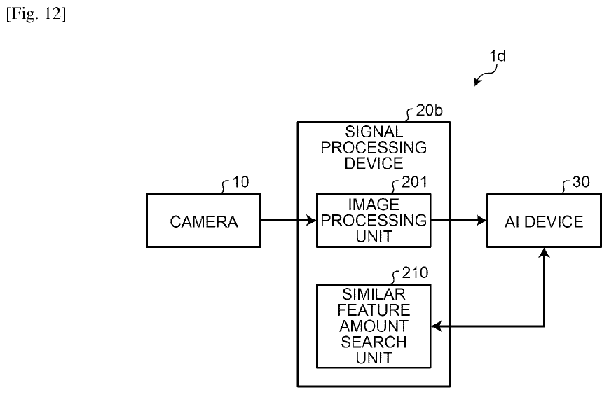

FIG. 12 is a functional block diagram of an example for explaining functions of a signal processing device 20 according to the second embodiment.

In FIG. 12, a signal processing device 20b included in an information processing system 1d according to the second embodiment includes an image processing unit 201 and a similar feature amount search unit 210.

The image processing unit 201 has a function equivalent to that of the image processing unit 201 described with reference to FIG. 4, and performs image processing for maximizing the image feature amount on the image data of the search region or the region of interest set to be predetermined with respect to the captured image data. More specifically, the image processing unit 201 maximizes the image feature amount of the image data by performing the histogram flattening, for example, on the image data of the search region or the region of interest. The image processing unit 201 passes the image data in which the image feature amount is maximized to an AI device 30.

The AI device 30 extracts an image feature amount from the image data passed from the signal processing device 20b, executes AI processing on the basis of the extracted image feature amount, and returns the image feature amount to the signal processing device 20b. In the signal processing device 20b, in a case where there are two or more image feature amounts passed from the AI device 30, the similar feature amount search unit 210 obtains a similarity between the two or more image feature amounts, and searches for a set of image feature amounts having a similarity greater than or equal to a predetermined value.

As a specific example, the similar feature amount search unit 210 extracts a region estimated as an object according to a distance between feature points or the like on the basis of the image feature amounts passed from the AI device 30. The similar feature amount search unit 210 obtains a similarity of the image feature amounts for each region extracted from each image data among the plurality of image data, and searches for a set of image feature amounts having a similarity greater than or equal to a predetermined value.

For example, in a case where the information processing system 1d according to the second embodiment is applied to the information processing system 1a including one camera 10 illustrated in FIG. 1A, the similar feature amount search unit 210 may obtain the similarity for a plurality of pieces of captured image data captured by the camera 10 at different times.

Furthermore, for example, in a case where the information processing system 1d according to the second embodiment is applied to the information processing system 1b including the plurality of cameras 10₁, 10₂, . . . illustrated in FIG. 1B, in at least one signal processing device among the signal processing devices 20₁, 20₂, . . . , for example, the signal processing device 201, each image feature amount extracted by the AI device 30′ from each image data output from the other signal processing devices 20₂, . . . may be acquired to obtain the similarity.

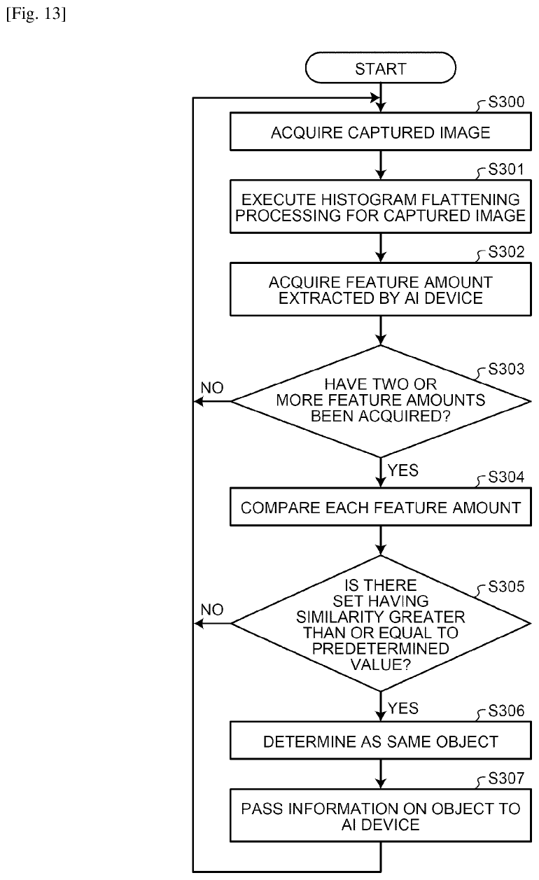

FIG. 13 is a flowchart illustrating an example of a process according to the second embodiment.

In Step S300, the signal processing device 20b acquires captured image data from the camera 10. In the next Step S301, in the signal processing device 20b, the image processing unit 201 executes histogram flattening processing on the captured image data acquired in Step S300. Here, in a case where a search region is set for the captured image data, the image processing unit 201 executes the histogram flattening processing on the image data included in the search region.

The signal processing device 20b passes the image data subjected to the histogram flattening processing by the image processing unit 201 to the AI device 30. The AI device 30 extracts a feature amount from the image data passed from the signal processing device 20b, and passes the extracted feature amount to the signal processing device 20b.

In the next Step S302, the signal processing device 20 acquires the image feature amount passed from the AI device 30. The signal processing device 20b passes the acquired image feature amount to the similar feature amount search unit 210. The similar feature amount search unit 210 holds the passed image feature amount.

In the next Step S303, the similar feature amount search unit 210 determines whether or not two or more image feature amounts have been acquired, that is, whether or not the image feature amounts held by the similar feature amount search unit 210 has become two or more. In a case where the similar feature amount search unit 210 determines that the acquired image feature amount is less than 2 (Step S303, “No”), the process returns to Step S300.

On the other hand, in a case where the similar feature amount search unit 210 determines that two or more image feature amounts have been acquired (Step S303, “Yes”), the process proceeds to Step S304. In Step S304, the similar feature amount search unit 210 compares the held image feature amounts and obtains similarity between the compared image feature amounts.

In the next Step S305, the similar feature amount search unit 210 determines whether or not there is a set having the similarity greater than or equal to a predetermined value among the sets of image feature amounts compared in Step S304. In a case where the similar feature amount search unit 210 determines that there is no set having the similarity greater than or equal to the predetermined value (Step S305, “No”), the process returns to Step S300.

On the other hand, in a case where the similar feature amount search unit 210 determines that there is a set having similarity greater than or equal to the predetermined value (Step S305, “Yes”), the process proceeds to Step S306. In Step S306, the similar feature amount search unit 210 determines that each image feature amount of a set having similarity greater than or equal to the predetermined value is the image feature amount of the same object. In the next Step S307, the signal processing device 20b passes, to the AI device 30, information indicating the objects determined to be the same in Step S306 by the similar feature amount search unit 210.

As described above, the information processing system 1d according to the second embodiment detects the same object included in the plurality of pieces of captured image data on the basis of the similarity of the image feature amounts extracted from the respective pieces of image data obtained by processing the plurality of pieces of captured image data by the signal processing device 20b. Therefore, by applying the information processing system 1d according to the second embodiment, it is possible to track an object commonly included in the plurality of pieces of captured image data different in time series or the plurality of pieces of captured image data acquired from the plurality of different cameras.

Furthermore, in this case, as the image feature amounts to be compared, the image feature amounts extracted after the histogram flattening processing is performed on the image data of the region to be subjected to the image feature amount extraction in the captured image data is used. Therefore, it is possible to absorb a difference in environment due to a time-series difference in the plurality of pieces of captured image data in the image feature amounts, a difference in installation positions of the cameras 10₁, 10₂, . . . , or the like.

### 5. Third Embodiment

Next, a third embodiment of the present disclosure will be described. A third embodiment of the present disclosure relates to a calibration method of the camera 10 and the signal processing device 20 (image processing unit 201) applicable to the first embodiment and the second embodiment described above. In the third embodiment, in particular, a calibration method using an image feature amount suitable for AI processing in the AI device 30 is proposed.

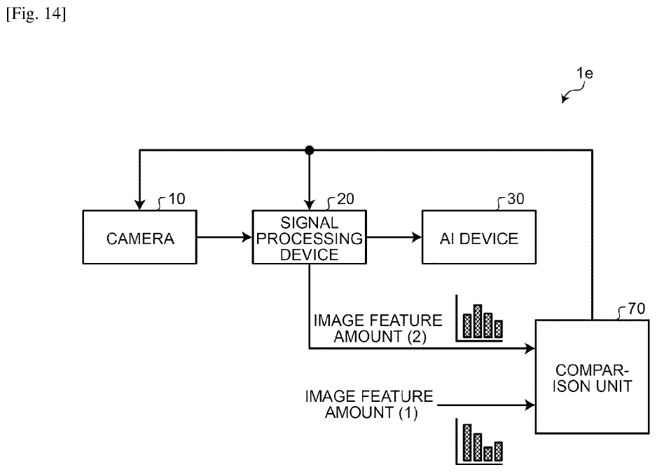

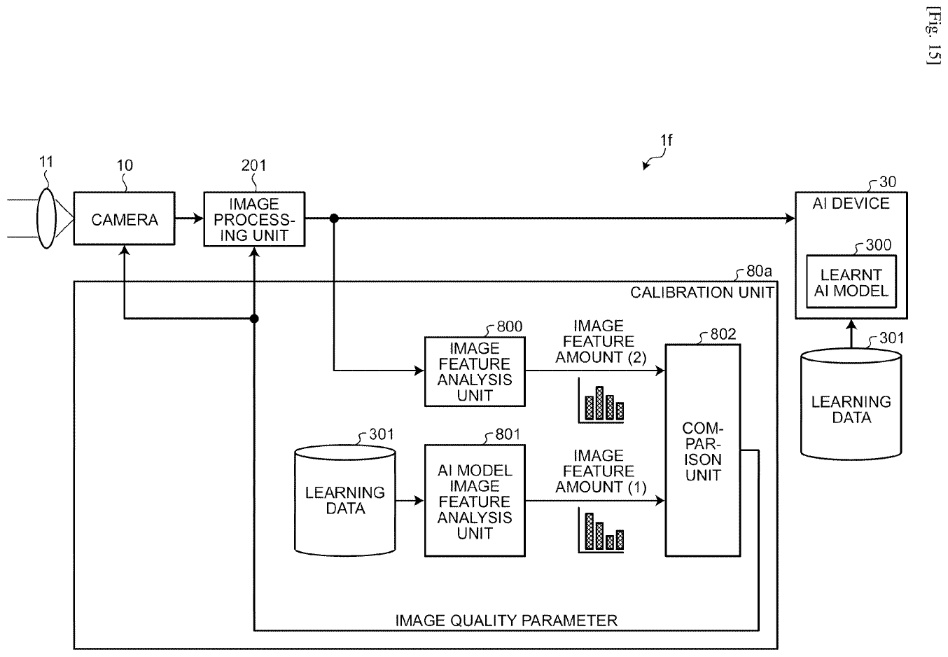

FIG. 14 is a block diagram illustrating a configuration of an example of an information processing system according to the third embodiment. In FIG. 14, an information processing system le includes a comparison unit 70 in addition to a camera 10, a signal processing device 20, and an AI device 30.

Here, the signal processing device 20 may execute general image processing on the image data such as luminance adjustment and saturation adjustment on the image data, in addition to the histogram flattening processing and the image feature amount extraction processing described above. That is, the AI device 30 is not limited to the AI processing based on the image feature amount extracted from the image data subjected to the histogram flattening processing described above, and may also execute the AI processing based on the image feature amount extracted from the image data subjected to the image processing other than the histogram flattening processing according to the use case. Therefore, the signal processing device 20 can also execute the above-described general image processing on the captured image data output from the camera 10.

The comparison unit 70 receives an image feature amount (2) extracted on the basis of the captured image data output from the camera 10 and an image feature amount (1) prepared in advance. As the image feature amount (1), an image feature amount suitable for the AI processing executed by the AI device 30 is used.

The comparison unit 70 compares the input image feature amount (1) with the input image feature amount (2), and obtains similarity between the image feature amount (1) and the image feature amount (2). The comparison unit 70 adjusts an image quality parameter for controlling image processing in at least the signal processing device 20 (image processing unit 201) of the camera 10 and the signal processing device 20 so that the obtained similarity is maximized.

The comparison unit 70 may apply parameters for controlling image quality such as luminance, saturation, and frequency component of image data as the image quality parameter for the signal processing device 20 (image processing unit 201). Furthermore, the comparison unit 70 may apply parameters for controlling the imaging operation (e.g., image capture settings of the image sensor), such as a shutter speed, an exposure time, and a gain, as the image quality parameter for the camera 10.

Processing based on comparison between the image feature amount (1) and the image feature amount (2) by the comparison unit 70 and adjustment of the camera 10 and the signal processing device 20 based on the image quality parameter generated on the basis of the comparison result is repeatedly executed as loop processing until the similarity becomes greater than or equal to a predetermined value, for example, and calibration of the camera 10 and the signal processing device 20 is performed. Note that this calibration processing does not necessarily need to be executed frequently, and for example, it is conceivable to execute the calibration processing once at the time of installation of a system to maximize performance, and then execute the calibration processing according to the timing when the environment changes, or the like. As an example of the timing at which the environment changes, for example, a timing according to a season transition in a case where the camera 10 is installed outdoors, or a timing according to an indoor layout change in a case where the camera 10 is installed indoors can be considered.

As described above, the information processing system le according to the third embodiment compares the image feature amount (1) prepared in advance with the image feature amount (2) extracted on the basis of the captured image data. As a result of the comparison, the information processing system le sets at least the image quality parameter of the signal processing device 20 out of the camera 10 and the signal processing device 20 such that the similarity between both the image feature amounts is maximized. Therefore, the AI processing in the AI device 30 can be executed with higher accuracy.

Note that, in the following description, unless otherwise specified, the image quality parameter for the image processing unit 201 and the image quality parameter for the camera 10 are collectively referred to as image quality parameter, and the image quality parameter is passed to each of the camera 10 and the image processing unit 201.

### (5-1. First Example)

Next, the calibration processing according to the third embodiment will be described more specifically. First, calibration processing according to a first example of the third embodiment will be described.

The first example of the third embodiment is an example in a case where learning data used for learning a learnt AI model used when the AI device 30 executes the AI processing is known. In the first example of the third embodiment, as the image feature amount (1) prepared in advance described above, an image feature amount based on the learning data used for learning the learnt AI model used when the AI device 30 executes the AI processing is used.

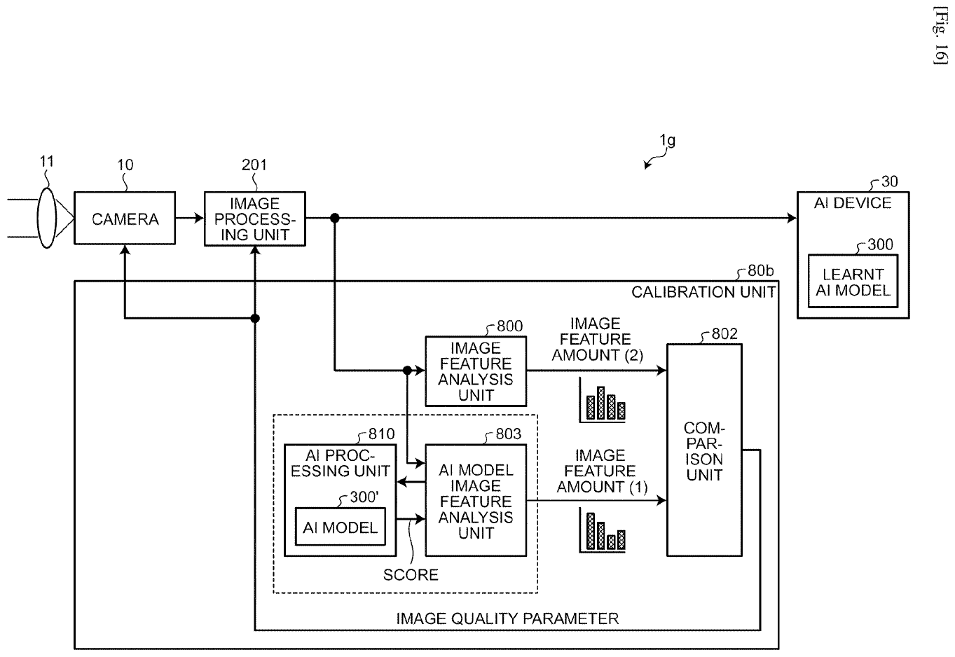

FIG. 15 is a block diagram illustrating a configuration of an example of an information processing system according to the first example of the third embodiment.

In FIG. 15, an information processing system 1f includes a calibration unit 80a in addition to the camera 10, the signal processing device 20, and the AI device 30. The calibration unit 80a may be included in the signal processing device 20, for example, or may be configured by independent hardware. The configuration is not limited thereto, and the AI device 30 may include the calibration unit 80a.

Note that, in FIG. 15, only the image processing unit 201 is illustrated as the signal processing device 20, and the other parts are omitted. The image processing unit 201 performs predetermined image processing on the captured image data output from the camera 10 and gives the captured image data to the AI device 30 and the calibration unit 80a.

The AI device 30 includes a learnt AI model 300 learnt with learning data 301. The AI device 30 extracts an image feature amount from the image data passed from the image processing unit 201, and executes the AI processing on the extracted image feature amount using the learnt AI model 300.

The calibration unit 80a includes an image feature analysis unit 800, an AI model image feature analysis unit 801, and a comparison unit 802.

The image feature analysis unit 800 analyzes image data obtained by applying image processing to the captured image data passed from the image processing unit 201, and extracts an image feature amount from the image data. The image feature analysis unit 800 passes the extracted image feature amount to the comparison unit 802 as the above-described image feature amount (2).

The AI model image feature analysis unit 801 analyzes the learning data 301 used to cause the learnt AI model 300 to learn, and extracts an image feature amount from the learning data 301. The AI model image feature analysis unit 801 passes the image feature amount extracted from the learning data 301 to the comparison unit 802 as the above-described image feature amount (2). For example, the AI model image feature analysis unit 801 integrates the image feature amounts extracted from each of the plurality of pieces of image data included in the learning data 301, and passes the integrated image feature amounts to the comparison unit 802 as the image feature amount (2).

The comparison unit 802 corresponds to the above-described comparison unit 70, and compares the image feature amount (1) with the image feature amount (2), calculates similarity between the image feature amount (1) and the image feature amount (2), and generates an image quality parameter that maximizes the calculated similarity. The comparison unit 802 generates an image quality parameter for controlling image processing of the image processing unit 201, for example, and passes the generated image quality parameter to the image processing unit 201. The comparison unit 802 may generate an image quality parameter for controlling the imaging operation of the camera 10, and pass the image quality parameter to the camera 10.

### (5-2. Second Example)

Next, calibration processing according to a second example of the third embodiment will be described.

The second example of the third embodiment is an example in a case where the learning data used for learning the learnt AI model used when the AI device 30 executes the AI processing is unknown. In the second example of the third embodiment, as the previously prepared image feature amount (1), the AI processing is executed on the captured image data using the model equivalent to the learnt AI model used when the AI device 30 executes the AI processing, and an image feature amount acquired on the basis of a result of the AI processing is used.

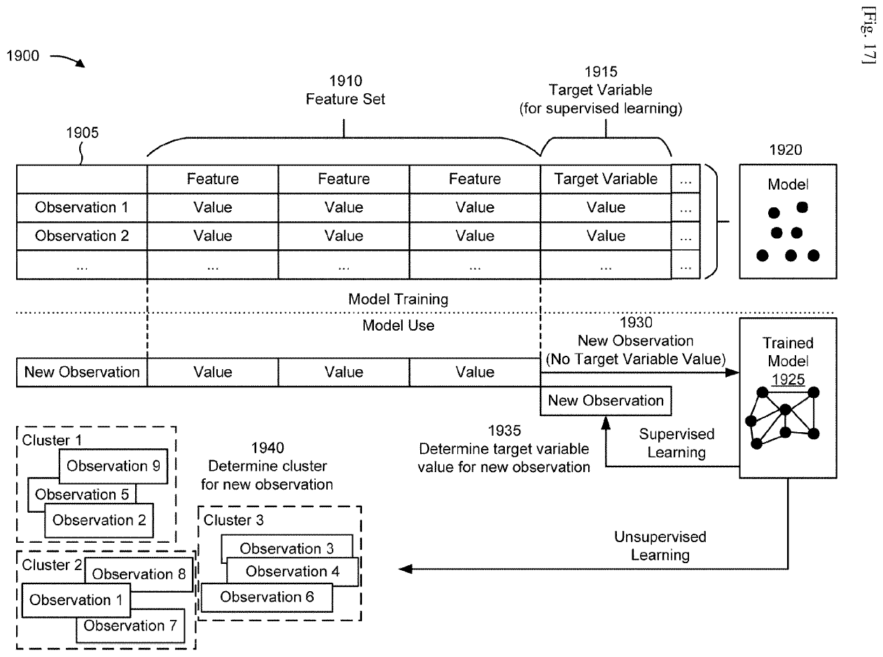

FIG. 16 is a block diagram illustrating a configuration of an example of an information processing system according to the second example of the third embodiment.

In FIG. 16, an information processing system 1g includes a calibration unit 80b instead of the calibration unit 80a illustrated in FIG. 15. The calibration unit 80b includes an image feature analysis unit 800, an AI model image feature analysis unit 803, and an AI processing unit 810. Furthermore, the AI processing unit 810 includes an AI model 300′. The AI model 300′ is the same model as the learnt AI model 300 included in the AI device 30. For example, the AI model 300′ may be a copy of the learnt AI model 300, or may be a model having a configuration equivalent to that of the learnt AI model 300 and learnt with learning data used to learn the learnt AI model 300.

The image processing unit 201 performs predetermined image processing on the captured image data output from the camera 10, and passes the captured image data to the AI device 30 and the calibration unit 80b. In the calibration unit 80b, the image data passed from the image processing unit 201 is passed to the image feature analysis unit 800 and the AI model image feature analysis unit 803.

Since the image feature analysis unit 800 is equivalent to the image feature analysis unit 800 illustrated in FIG. 15, the description thereof will be omitted here.

The AI model image feature analysis unit 803 analyzes the image data passed from the image processing unit 201 to extract an image feature amount, and passes the extracted image feature amount to the AI processing unit 810. The AI processing unit 810 executes the AI processing (for example, recognition processing) on the image feature amount passed from the AI model image feature analysis unit 803 using the AI model 300′, and calculates a score indicating the degree of detection. The score calculated by the AI processing unit 810 is not particularly limited, but an average precision (AP) value, a heat map, or the like may be applied. The AI processing unit 810 returns the calculated score to the AI model image feature analysis unit 803.

Here, the image processing unit 201 may perform various types of image processing on one piece of captured image data output from the camera 10 to generate a plurality of pieces of image data having different properties. For example, the image processing unit 201 may generate image data in which luminance, saturation, hue, and the like are changed, image data to which noise is added, image data to which enlargement/reduction/deformation is performed, image data to which edge enhancement or blur is added, and the like by image processing on the captured image data.

The AI model image feature analysis unit 803 compares each score passed from the AI processing unit 810 according to each image data passed from the image processing unit 201, and specifies image data having the highest score. The image data specified in this manner can be regarded as image data having a property most suitable for AI processing using the AI model 300′ by the AI processing unit 810. The AI model image feature analysis unit 803 extracts the image feature amount of the image data specified as having obtained the highest score, and passes the image feature amount to a comparison unit 802 as the image feature amount (1).

Similarly to the comparison unit 802 in the first example described above, the comparison unit 802 compares the image feature amount (1) with the image feature amount (2) to calculate similarity therebetween, generates an image quality parameter that maximizes the calculated similarity, and passes the generated image quality parameter to the image processing unit 201 and the camera 10.

Note that the image data passed to the AI model image feature analysis unit 803 may be different from the image data passed to the image feature analysis unit 800. For example, image data obtained by performing image processing by the image processing unit 201 on the captured image data captured in advance by the camera 10 may be passed to the AI model image feature analysis unit 803. In this case, an imaging range of the camera 10 needs to correspond to an imaging range of the camera 10 when the original captured image data of the image data passed to the image feature analysis unit 800 is captured.

According to the second example of the third embodiment, even if the learning data used for learning of the learnt AI model 300 included in the AI device 30 is unknown, calibration of the camera 10 and the image processing unit 201 can be executed. Furthermore, according to the second example of the third embodiment, since the image feature amount (1) is generated on the basis of the captured image data captured by the camera 10, it is possible to dynamically generate the image quality parameter for the camera 10 and the image processing unit 201, and thereby, it is possible to maximize the detection accuracy by the AI device 30 regardless of the installation environment of the camera 10.

FIG. 17 is a diagram illustrating an example 1900 of training and using a machine learning model in connection with computer vision and/or image processing (e.g., object detection, facial recognition, and/or image segmentation, among other examples). This machine learning model may be used to develop a deep neural network (DNN) as an AI engine, which is subsequently segmented, in accordance with embodiments of the disclosure outlined above. The machine learning model training and usage described herein may be performed using a machine learning system. The machine learning system may include, or may be included in, a computing device, a server, and/or a cloud computing environment, among other examples, such as the image processing system, as described in more detail elsewhere herein.

As shown by reference number 1905, a machine learning model may be trained using a set of observations. The set of observations may be obtained from training data (e.g., historical visual observation data associated with visual records and/or image data), such as data gathered during one or more processes described herein. In some implementations, the machine learning system may receive the set of observations (e.g., as input) from the image processing system, as described elsewhere herein.

As shown by reference number 1910, the set of observations (e.g., visual observation data) may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the image processing system For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include features of color distribution, texture features, shape descriptors, edge features, corner features, object sizes, area proportions, orientations, aspect ratios, specific objects such as people or aspects of people, and/or color dominance, among other examples. As shown, for a first observation, the features may have values of color histogram values, texture attribute values, shape moment values, edge response values, corner response values, object size values, area proportion values, orientation values, aspect ratio values, color dominance values, and/or gradient magnitudes, among other examples. These features and feature values are provided as examples and may differ in other examples.

As shown by reference number 1915, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, and/or labels, among other examples) and/or may represent a variable having a Boolean value. A target variable may be associated with a target variable value, and a target variable value may be specific to an observation. In example 1900, the target variable may be an object category (e.g., associated with identifying the category or type of an object in an image), emotion recognition (e.g., associated with predicting the emotion expressed in a facial image), segmentation mask (e.g., associated with generating pixel-level segmentation masks to outline and classify different regions or objects in an image), pose estimation (e.g., associated with predicting the pose or orientation of an object in an image), image quality assessment (e.g. associated with estimating the quality of an image), anomaly detection (e.g., associated with identifying unusual or anomalous regions in an image), image captioning (e.g., associated with generating descriptive captions or textual explanations for the content of an image), age estimation (e.g., associated with predicting an age of individuals depicted in an image), optical character recognition (OCR) (e.g., associated with recognizing and extracting text from images, image similarity (e.g., associated with calculating similarity scores between images to group similar images together), among other examples.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 1920, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 1925 to be used to analyze new observations.

As an example, the machine learning system may obtain training data for the set of observations based on image preprocessing techniques, as described in more detail elsewhere herein.

As shown by reference number 1930, the machine learning system may apply the trained machine learning model 1925 to a new observation (e.g., a new visual observation), such as by receiving a new observation and inputting the new observation to the trained machine learning model 1925. In the context of image processing, a new observation may include features of image pixel values, edge maps, among other examples). The machine learning system may apply the trained machine learning model 1925 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 1925 may predict a value of tree for the target variable of “type of object present in an image” for the new observation, as shown by reference number 1935. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a suggested object category of tree. The first automated action may include, for example, classifying the object into an object category of tree.

In some implementations, the trained machine learning model 1925 may classify (e.g., cluster) the new observation in a cluster, as shown by reference number 1940. The observations within a cluster may have a threshold degree of similarity. For example, if the historical records indicate similar image characteristics, then the images likely depict related objects. As an example, if the machine learning system classifies the new observation in a first cluster (e.g., trees), then the machine learning system may provide a first recommendation, such as the first recommendation described above.

As another example, if the machine learning system were to classify the new observation in a second cluster (e.g., a face), then the machine learning system may provide a second (e.g., different) recommendation (e.g., suggest an object category of the face, if desired).

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 1925 may be retrained using feedback information. For example, feedback may be provided to the machine learning model. The feedback may be associated with actions performed based on the recommendations provided by the trained machine learning model 1925 and/or automated actions performed, or caused, by the trained machine learning model 1925. In other words, the recommendations and/or actions output by the trained machine learning model 1925 may be used as inputs to re-train the machine learning model (e.g., a feedback loop may be used to train and/or update the machine learning model). For example, the feedback information may include a correct object category suggestion that is an output from the model.

In this way, the machine learning system may apply a rigorous and automated process to computer vision and/or image processing, as described in more detail elsewhere herein. The machine learning system may enable recognition and/or identification of tens, hundreds, thousands, or millions of features and/or feature values for tens, hundreds, thousands, or millions of observations, thereby increasing accuracy and consistency and reducing delay associated with computer vison and/or image processing relative to requiring computing resources to be allocated for tens, hundreds, or thousands of operators to manually process visual observations and/or images using the features or feature values.

As indicated above, FIG. 17 is provided as an example. Other examples may differ from what is described in connection with FIG. 17.

Note that the effects described in the present specification are merely examples and are not limited, and other effects may be provided.

### REFERENCE SIGNS LIST

1a, 1b, 1c, 1d, 1e, 1f, 1g Information processing system
10, 10₁, 10₂ Camera
11 Optical unit
20, 20₁, 20₂, 20a, 20b Signal processing device
30, 30′ AI device
40 Captured image data
50 Search region
60, 60a, 60b, 60c Object
61, 61a, 61b, 61c, 61d, 61e, 61f Bounding box
62a, 62b Coordinates of center of gravity
70 Comparison unit
80a, 80b Calibration unit
200 Region control unit
201 Image processing unit
202 Detection result processing unit
210 Similar feature amount search unit
300 Learnt AI model
300′ AI model
301 Learning data
800 Image feature analysis unit
801, 803 AI model image feature analysis unit
802 Comparison unit
810 AI processing unit

1. An information processing system comprising:
circuitry configured to
set a region of interest (ROI) as a subportion of an image, the image comprising image data,
flatten a portion of the image data that corresponds to the ROI to create flattened ROI image data, and
apply the flattened ROI image data to a trained AI engine to detect a feature in the subportion of the image.

2. The information processing system of claim 1, wherein
the circuitry is further to configured to set other ROIs of the image, each of the other ROIs corresponding to different subportions of the image data.

3. The information processing system of claim 2, wherein
the ROI and the other ROIs are predetermined subportions of the image that do not overlap one another.

4. The information processing system of claim 1, wherein
the trained AI engine is configured by being trained with training data that includes a label that corresponds the feature in the subportion of the image.

5. The information processing system of claim 1, wherein
the circuitry is configured to flatten ROI image data by application of a histogram flattening process on the ROI image data.

6. The information processing system of claim 1, wherein
the circuitry is configured to generate a bounding box around the feature under a condition that the AI engine has detected a presence of the feature in the ROI.

7. The information processing system of claim 1, wherein
under a condition the AI engine detects an additional feature in the ROI, the circuitry is configured to
generate another bounding box for each additional feature detected in the ROI, and
determine a total number of bounding boxes in the ROI.

8. The information processing system of claim 2, wherein
the circuitry is configured to select between the ROI and the other ROIs to identify an ROImax that has a most number of bounding boxes.

9. The information processing system of claim 1, wherein
the image data includes one or more frames of video.

10. The information processing system of claim 1, wherein
the circuitry is configured to generate a bounding box around the feature and other detected features present in the image data, and then set the ROI in a subportion of the image that has a greatest number of bounding boxes.

11. A control system comprising:
circuity configured to
analyze predetermined training data to determine a first feature weight of a feature included in the predetermined training data,
analyze image data from a controllable image sensor to determine a second feature weight of the feature in the image data,
compare the first feature weight with the second feature weight to determine an image quality parameter, and
control an operation of the controllable image sensor via application of the image quality parameter as a control parameter to the controllable image sensor such that the second feature weight provided from the controllable image sensor made to be closer in value to the first feature weight.

12. The control system of claim 11, wherein the circuitry is further configured to
implement an AI engine that has been trained on training data to detect the feature in image data, and
analyze the image data from a controllable image sensor with the AI engine to determine the second feature weight.

13. The control system of claim 11, wherein the circuitry is further configured to
implement an AI engine that has been trained on training data to detect the feature in image data, and
analyze the image data from the controllable image sensor along with a degree of detection score from the AI engine to determine the first feature weight.

14. A controllable image sensor comprising:
an image sensor configured to capture a first image and a second image, the second image being captured subsequent to the first image; and
image processing circuitry configured to
receive, from the image sensor, first image data corresponding to the first image, and second image data corresponding to the second image, and
control an operation of the controllable image sensor to affect the second image data that is output from the controllable image sensor based on an image quality parameter received from calibration circuitry, wherein
the image quality parameter corresponds to a comparison result by the calibration circuitry of
a first feature weight provided by image feature analysis circuitry based on the first image data, and
a second feature weight provided by a trained AI image feature engine that has been trained to detect a feature in image data, the trained AI image feature engine produces the second feature weight in response to the first image data applied as an input.

15. The controllable image sensor of claim 14, wherein
the image quality control parameter is a control parameter that sets an image capture setting of the image sensor.

16. The controllable image sensor of claim 14, wherein
the image quality control parameter configures an image processing operation performed by the image processing circuitry on image data provided to the image processing circuitry from the image sensor.

17. The controllable image sensor of claim 14, further comprising the calibration circuitry.

18. The controllable image sensor of claim 14, further comprising AI-based feature weight circuitry that determines a feature weight of respective features contained in image data provided by the image processing circuitry for additional images.

19. The controllable image sensor of claim 17, wherein
the image processing circuitry is configured to provide to the calibration circuitry the second image data after the second image data has been affected by the controllable image sensor.

20. The controllable image sensor of claim 14, wherein
the trained AI image feature engine of the calibration circuitry is further trained on image data provided by the image processing circuitry.
